(19) United States
(12) Patent Application Publication
(10) Pub. No.: US 2004/0205558 A1
(43) Pub. Date: Oct. 14, 2004

(54) Method and apparatus for enhancement of web searches

(75) Inventors: Lane Thomas Holloway, Pflugerville, TX (US); Nadeem Malik, Austin, TX (US); Marques Benjamin Quiller, Austin, TX (US)

Correspondence Address: IBM CORP (YA), C/O YEE & ASSOCIATES PC, P.O. BOX 802333, DALLAS, TX, 75380, US

(73) Assignee: IBM Corporation

(21) Appl. No.: 09/981,904

(22) Filed: Oct. 18, 2001

(51) Int. Cl. G06F 17/30

(52) U.S. Cl. 715/513; 707/3

(57) ABSTRACT

A method, apparatus, and computer instructions for processing a Web page. A search query is sent from a browser to a search engine in which the search query includes a search term. The Web page is received in response to sending the query including a search term. Each instance of the search term present in the Web page is highlighted.

### BACKGROUND OF THE INVENTION

1. Technical Field

The present invention relates generally to an improved data processing system, and in particular to a method and apparatus for processing data. Still more particularly, the present invention provides a method, apparatus, and computer instructions for processing a Web page returned from a search.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Various search engines are available on the Web for use by users to locate Web pages of interest. A user enters keywords relating to a subject matter of interest to the user. These keywords form a search query which is sent to the search engine. A set of results is returned to the user. These results are often a set of links in a Web page. The user may then select a link to view a Web page matching the search query. In reviewing the Web page, the user may desire to review a portion or section of the page containing the keywords. One problem encountered by the user is that the user must manually activate a “find” function to identify keywords in the Web page. Although such an activity is not extremely difficult, performing these extra steps may cause the user to lose focus on the subject or slow down the review of the results. These extra steps may be time consuming depending on the number of Web pages returned for review by the user.

Therefore, the present invention provides an improved method, apparatus, and computer instructions for allowing a user to quickly focus on a section of interest in a Web page.

### SUMMARY OF THE INVENTION

The present invention provides a method, apparatus, and computer instructions for processing a Web page. A search query is sent from a browser to a search engine in which the search query includes a search term. The Web page is received in response to sending the query including a search term. Each instance of the search term present in the Web page is highlighted.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating data flow in enhancing a Web search in accordance with a preferred embodiment of the present invention;

FIG. 5 is a block diagram of a browser program in accordance with a preferred embodiment of the present invention;

FIGS. 6A and 6B are diagrams illustrating tags used to highlight search terms in accordance with a preferred embodiment of the present invention; and

FIG. 7 is a flowchart of a process used to highlight search terms in a Web page in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables. In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. In particular, server 104 may provide Web pages to the clients in response to receiving requests containing search queries. These Web pages may be located at server 104 or at storage unit 106. The process of the present invention provides a mechanism to allow a user to quickly focus on a section of interest within a Web page identified in a set of results in response to a query. In these examples, the mechanism is located in the client, such as client 108, 110, or 112. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

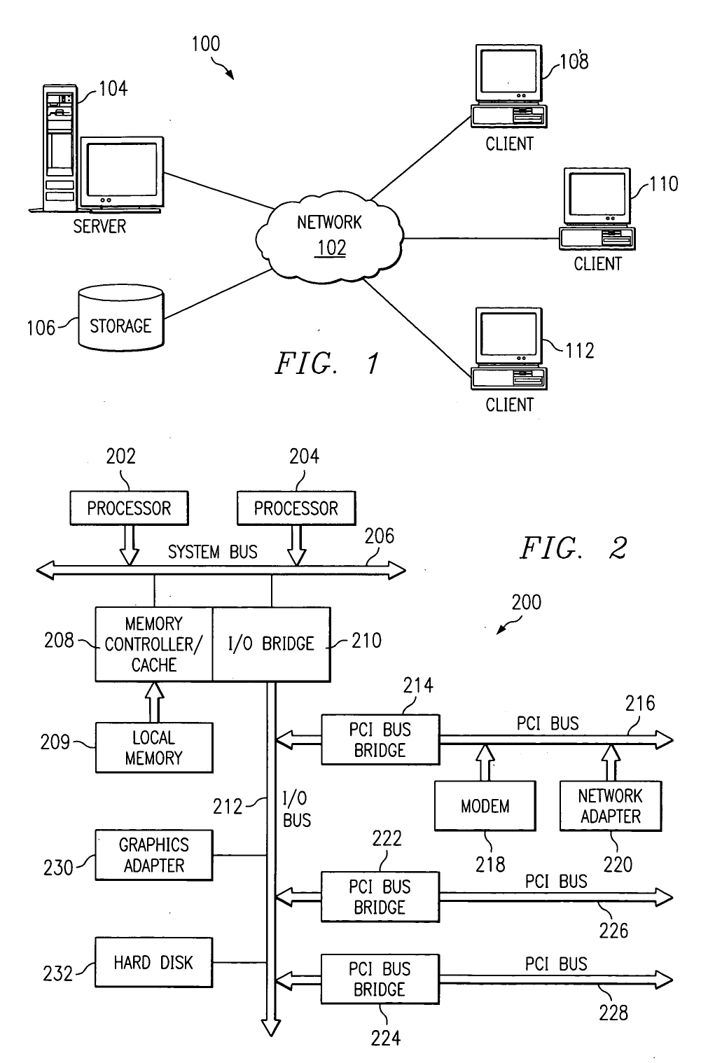

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, New York, running the Advanced Interactive Executive (AIX) operating system or LINUX operating system.

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

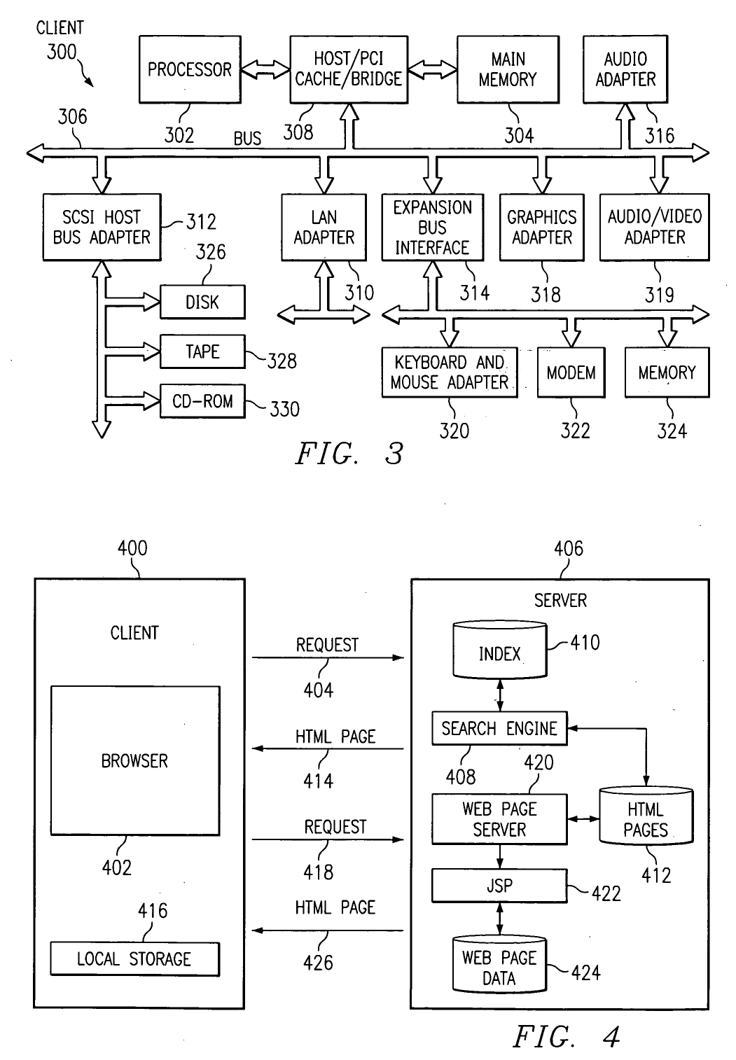

Turning next to FIG. 4, a diagram illustrating data flow in enhancing a Web search is depicted in accordance with a preferred embodiment of the present invention. In this example, client 400 includes a browser 402, which is employed by a user to generate a search query. The user may enter keywords into browser 402 to generate request 404, which is sent to server 406 for processing by search engine 408. These keywords are search terms used by search engine 408 to identify a set of results. Other types of search terms may be a phrase or sentence entered by a user. In these examples, the communication between client 400 and server 406 occurs using Hypertext Transfer Protocol (HTTP) although other protocols may be used depending on the particular implementation.

Upon receiving request 404, search engine 408 may search for Web pages corresponding to the keywords in request 404. Various well-known mechanisms may be used to determine what Web pages correspond sufficiently to be included in a set of results. For example, a Web page may be identified as a result if all of the keywords are present in the Web page. Alternatively, a Web page may be identified as a result if the keywords occur a certain number of times within the Web page. Additionally, A Web page may be identified as a result if the requested keyword is located in the Web page's following HTML tag: <meta name=“keywords” content=“requested keyword”>. Search engine 408 may search for results in index database 410, which in this example contains identifications of Web pages, which have been indexed for purposes of searching. An index, such as index database 410, contains a searchable catalog of documents created by search engine software. Further, search engine 408 may search HTML pages database 412 for Web pages corresponding to the search results. In these examples, a Web page in the form of HTML page 414 is generated for return to browser 402 in client 400. HTML page 414 contains a set of results, which may be a list of links to Web pages returned in the search performed by search engine 408. HTML page is stored in local storage 416. This Web page is displayed in browser 402 to the user. The user may select a Web page from the results in HTML page 414 to generate request 418. This request is sent to the server identified by the URL in the link.

In this example, this server is the same server that performed the search, server 406. This request is processed by Web page server 420, which may retrieve a Web page from HTML page 414 or dynamically generate a Web page using Java server page (JSP) 422. A JSP is an extension to the Java servlet technology from Sun that provides a simple programming vehicle for displaying dynamic content on a Web page. The JSP is an HTML page with embedded Java source code that is executed in the Web server or application server. The HTML provides the page layout that will be returned to the Web browser, and the Java provides the processing; for example, to deliver a query to the database and fill in the blank fields with the results. In this example, the information used to fill the HTML page is located in Web page data database 424.

After the appropriate Web page is located or generated, HTML page 426 is returned to browser 402. In these examples, browser 402 will parse HTML page 426 for keywords used in the search query sent in request 404. Keywords identified within HTML page 426 are highlighted in the display of the page to the user to allow the user to quickly focus on the section of interest in HTML page 426. These keywords are stored when the search query was initially sent in request 404 to search engine 408.

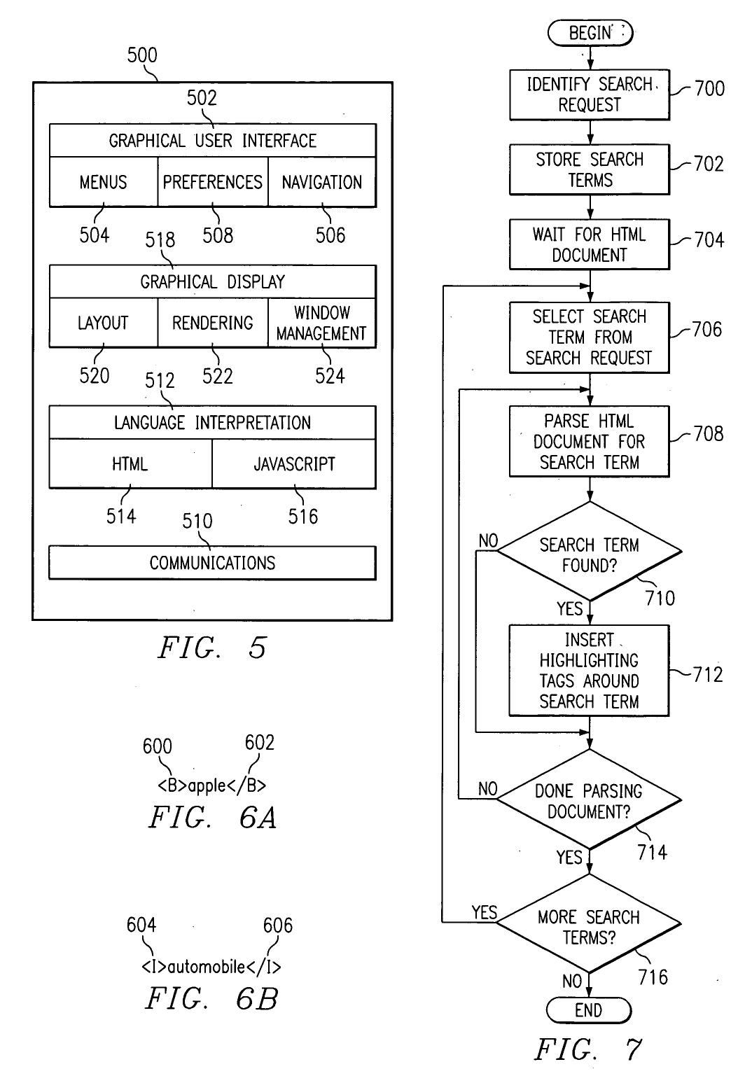

Turning next to FIG. 5, a block diagram of a browser program is depicted in accordance with a preferred embodiment of the present invention. A browser is an application used to navigate or view information or data in a distributed database, such as the Internet or the World Wide Web. Browser 500 is an example of browser 402 in FIG. 4, which is used by a user to search for Web pages.

In this example, browser 500 includes a user interface 502, which is a graphical user interface (GUI) that allows the user to interface or communicate with browser 500. This interface provides for selection of various functions through menus 504 and allows for navigation through navigation 506. For example, menu 504 may allow a user to perform various functions, such as saving a file, opening a new window, displaying a history, and entering a URL. Navigation 506 allows for a user to navigate various pages and to select web sites for viewing. For example, navigation 506 may allow a user to see a previous page or a subsequent page relative to the present page. Preferences such as those illustrated in FIG. 5 may be set through preferences 508.

Communications 510 is the mechanism with which browser 500 receives documents and other resources from a network such as the Internet. Further, communications 510 is used to send or upload documents and resources onto a network. In the depicted example, communication 510 uses HTTP. Other protocols may be used depending on the implementation. Documents that are received by browser 500 are processed by language interpretation 512, which includes an HTML unit 514 and a JavaScript unit 516. Language interpretation 512 will process a document for presentation on graphical display 518. In particular, HTML statements are processed by HTML unit 514 for presentation while JavaScript statements are processed by JavaScript unit 516. In these examples, HTML unit 514 includes the processes of the present invention. These processes are used to parse an HTML page to identify search terms, such as keywords, sentences, or phrases, which were entered by the user to form a search query. When a search term is identified in the HTML page, the search term is highlighted by adding a pair of tags to encompass the search term. In particular, one tag is placed before the search term and the other tag is placed after the search term. These tags are used to highlight or provide an emphasis for the search term when it is displayed by browser 500. These tags are inserted into a copy of the HTML page in a memory at the client, such as local storage 416 in FIG. 4. In this manner, no alteration to the HTML page stored on the server is required. Further, this type of implementation provides an additional advantage because no changes are needed to the many different search engines presently used.

In these examples, although the mechanism of the present invention is implemented in HTML unit 514, these processes may be implemented in other ways. For example, a plug-in or a separate application may be used to process the HTML page. A plug-in is an auxiliary program that works with a software program to enhance its capability.

Graphical display 518 includes layout unit 520, rendering unit 522, and window management 524. These units are involved in presenting web pages to a user based on results from language interpretation 512.

Browser 500 is presented as an example of a browser program in which the present invention may be embodied. Browser 500 is not meant to imply architectural limitations to the present invention. Presently available browsers may include additional functions not shown or may omit functions shown in browser 500. A browser may be any application that is used to search for and display content on a distributed data processing system. Browser 500 may be implemented using known browser applications, such as Netscape Navigator or Microsoft Internet Explorer. Netscape Navigator is available from Netscape Communications Corporation while Microsoft Internet Explorer is available from Microsoft Corporation.

Turning next to FIGS. 6A and 6B, diagrams illustrating tags used to highlight search terms are depicted in accordance with a preferred embodiment of the present invention. In FIG. 6A, the search term “apple” is encompassed by tag 600 and tag 602. These tags will cause a search term to be highlighted by placing the search term in bold. Next in FIG. 6B, tag 604 and tag 606 are placed around the search term “automobile” and provide highlighting in the form of causing this search term to be displayed in italics. Tags 600, 602, 604, and 606 are also referred to as highlighting tags.

These two examples are presented for purposes of illustration and are not intended to limit the manner in which a search term may be highlighted. For example, the search may be highlighted by using underlining, setting a font type, setting a color, setting a font size, or causing the search term to flash.

Turning next to FIG. 7, a flowchart of a process used to highlight search terms in a Web page is depicted in accordance with a preferred embodiment of the present invention. The process illustrated in FIG. 7 may be implemented in a browser, such as browser 500 in FIG. 5. More specifically, the process may be implemented in HTML unit 514. Alternatively, for example, the process may be located in a plug-in for use with browser 500.

The process begins by identifying a search request (step 700). Search terms are stored (step 702). These search terms, may be, for example, keywords, sentences, or phrases. The process waits for the HTML document to be received (step 704). In this example, the process waits for an actual HTML document corresponding to the search request rather than the list of results. Search terms are selected from the search request (step 706). The HTML document is parsed for a search term (step 708).

Next, a determination is made as to whether the search term is found (step 710). If the search term is found, highlighting tags are inserted around the search term (step 712). Examples of these highlighting tags are illustrated in FIGS. 6A and 6B.

A determination is then made as to whether parsing of the document is complete (step 714). Parsing completes if the entire document has been searched for the search terms. If document parsing is complete, a determination is made as to whether additional search terms are present that have not been used in parsing the document (step 716). If additional search terms are absent, the process terminates.

Turning again to step 716, if additional search terms are present, the process returns to step 706 as described above. Referring again to step 714, if the document parsing is not complete, the process returns to step 708 as described above. With reference to step 710, if a search term is not found, the process proceeds to step 714 as described above.

Thus, the present invention provides an improved method, apparatus, and computer instructions for enhancing Web searches. This advantage is provided through a highlighting or emphasis mechanism in the browser, which highlights search terms present within a Web page. This mechanism allows for highlighting of search terms without requiring changes to the HTML document stored on the server. Further, no modifications to search engines are required. This mechanism may be implemented directly within the browser or through a plug-in.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted examples illustrate a search query in the form of a keyword search, the mechanism of the present invention may be applied to any type of search. For example, the highlighting may be applied to a phrase search, which is a search for documents containing an exact sentence or phrase specified by a user. In this case, the entire sentence or phrase is highlighted. Further, the mechanism of the present invention may be applied to other types of markup languages, other than HTML. For example, this process may be applied to extensible markup language (XML) documents.

The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for processing a Web page, the method comprising:
sending a search query from a browser to a search engine, wherein the search query includes a search term;
receiving the Web page in response to sending the query including a search term; and
highlighting each instance of the search term present in the Web page.

2. The method of claim 1, wherein the Web page is a markup language document.

3. The method of claim 1, wherein the Web page is a hypertext markup language document.

4. The method of claim 1, wherein the sending step, the receiving step, and the highlighting step are performed in one of a browser or a plug-in to a browser.

5. The method of claim 1, wherein the highlighting step comprises:
adding a first tag before the search term and a second tag after the search term, wherein the first tag and the second tag are used to change in emphasis of the search term within the Web page.

6. The method of claim 4, wherein the change in emphasis causes the search term to be displayed as at least one of bold, underlined, italicized, and flashing.

7. The method of claim 4, wherein the change in emphasis causes the search term to be displayed as at least one of a different color, a different size, and a different font.

8. The method of claim 1, wherein the search term is one of a keyword, a sentence, or a phrase.

9. The method in a browser for displaying a Web page, comprising:
receiving a Web page identified as a result of a query, wherein the query includes a search term;
parsing the Web page for each instance of the search term in the Web page to form a set of identified search terms;
encompassing each identified search term in the set of identified search terms with a pair of tags to form a new Web page; and
displaying the new Web page, wherein the pair of tags causes each search term located within the document to be highlighted in the Web page.

10. The method of claim 9, wherein the Web page is a markup language document.

11. The method of claim 10, wherein the Web page is a hypertext markup language document.

12. The method of claim 9, wherein the result is received from a Web server.

13. The method of claim 9, wherein the pair of tags sets one of a color, font type, bold, underline, italics, or font size for the search term encompassed by the pair of tags.

14. The method of claim 9, wherein the search term is one of a keyword, a sentence, or a phrase.

15. A data processing system comprising:
a bus system;
a communications unit connected to the bus system;
a memory connected to the bus system, wherein the memory includes a set of instructions; and
a processing unit connected to the bus system, wherein the processing unit executes the set of instructions to send a search query from a browser to a search engine in which the search query includes a search term, receive the Web page in response to sending the query including a search term, and highlight each instance of the search term present in the Web page.

16. A data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a Web page identified as a result of a query in which the query includes a search term, parse the Web page for each instance of the search term in the Web page to form a set of identified search terms, encompass each identified search term in the set of identified search terms with a pair of tags to form a new Web page; and display the new Web page in which the pair of tags causes each search term located within the document to be highlighted in the Web page.

17. A data processing system for processing a Web page, the data processing system comprising:
sending means for sending a search query from a browser to a search engine, wherein the search query includes a search term;
receiving means for receiving the Web page in response to sending the query including a search term; and
highlighting means for highlighting each instance of the search term present in the Web page.

18. The data processing system of claim 17, wherein the Web page is a markup language document.

19. The data processing system of claim 17, wherein the Web page is a hypertext markup language document.

20. The data processing system of claim 17, wherein the sending means, the receiving means, and the highlighting means are performed in one of a browser or a plug-in to a browser.

21. The data processing system of claim 17, wherein the highlighting means comprises:
adding means for adding a first tag before the search term and a second tag after the search term, wherein the first tag and the second tag are used to change in emphasis of the search term within the Web page.

22. The data processing system of claim 20, wherein the change in emphasis causes the search term to be displayed as at least one of bold, underlined, italicized, and flashing.

23. The data processing system of claim 20, wherein the change in emphasis causes the search term to be displayed as at least one of a different color, a different size, and a different font.

24. The data processing system of claim 17, wherein the search term is one of a keyword, a sentence, or a phrase.

25. The data processing system in a browser for displaying a Web page, comprising:
receiving means for receiving a Web page identified as a result of a query, wherein the query includes a search term;
parsing means for parsing the Web page for each instance of the search term in the Web page to form a set of identified search terms;
encompassing means for encompassing each identified search term in the set of identified search terms with a pair of tags to form a new Web page; and
displaying means for displaying the new Web page, wherein the pair of tags causes each search term located within the document to be highlighted in the Web page.

26. The data processing system of claim 25, wherein the Web page is a markup language document.

27. The data processing system of claim 26, wherein the Web page is a hypertext markup language document.

28. The data processing system of claim 25, wherein the result is received from a Web server.

29. The data processing system of claim 25, wherein the pair of tags sets one of a color, font type, bold, underline, italics, or font size for the search term encompassed by the pair of tags.

30. The data processing system of claim 25, wherein the search term is one of a keyword, a sentence, or a phrase.

31. A computer program product in a computer readable medium for processing a Web page, the computer program product comprising:
first instructions for sending a search query from a browser to a search engine, wherein the search query includes a search term;
second instructions for receiving the Web page in response to sending the query including a search term; and
third instructions for highlighting each instance of the search term present in the Web page.

32. A computer program product in a computer readable medium in a browser for displaying a Web page, the computer program product comprising:
first instructions for receiving a Web page identified as a result of a query, wherein the query includes a search term;
second instructions for parsing the Web page for each instance of the search term in the Web page to form a set of identified search terms;
third instructions for encompassing each identified search term in the set of identified search terms with a pair of tags to form a new Web page; and
fourth instruction for displaying the new Web page, wherein the pair of tags causes each search term located within the document to be highlighted in the Web page.
